(19) United States
(12) Patent Application Publication
(10) Pub. No.: US 2014/0201097 A1
(43) Pub. Date: Jul. 17, 2014

(54) Method and System for Comparing and Advising Individuals and Groups

(71) Applicant: Jeffrey Seltzer, Encino, CA (US)

(72) Inventor: Jeffrey Seltzer, Encino, CA (US)

(21) Appl. No.: 14/155,191

(22) Filed: Jan. 14, 2014

Related U.S. Application Data
(60) Provisional application No. 61/752,764, filed on Jan. 15, 2013.

(51) Int. Cl. G06Q 50/00; G06F 17/30

(52) U.S. Cl. CPC G06Q 50/01; G06F 17/30867
USPC 705/319

(57) ABSTRACT

A system and method for comparing individuals, relationships and partners in a relationship and soliciting relationship advice are provided. It allows for a first user to submit a dating/relationship couple and question(s) through a relationship submission interface. A second user can submit a response to a question about the members of the couple or the couple itself through an answer submission interface. The various submissions are stored and retrieved for users to view the results.

### CROSS REFERENCE TO RELATED APPLICATIONS

This application claims priority from a provisional U.S. patent application No. 61/752,764 filed on Jan. 15, 2013.

### FIELD OF THE INVENTION

The invention generally relates to internet dating services and relationship dating advice via the World Wide Web. Embodiments of the invention generally relate web browsing and application service providers (ASPs) such as social networking applications.

### BACKGROUND OF THE INVENTION

Internet dating services have grown in popularity since their inception. This can be attributed to a society that has become more dependent on technology and does not want to nor can afford to spend a lot of time searching for relationship partners. Online dating services benefit from more members that increase the pool of possible partners.

The World Wide Web is also a common means of finding information and having questions answered. Cooperative efforts like Wikipedia, as well as forums, allow individuals to find information and have questions answered by active users. Additionally, some web sites allow users to answer simple “Yes/No” questions or choose between 2 choices allowing users to contribute in a quick efficient manner.

While online dating services serve to match prospective dating partners, there are not efficient online services that use large pool of users to provide dating advice. There is a need for such a web service that uses the benefits of a large online community to give relationship advice and recommendations to individuals in a relationship in a quick, user friendly manner.

### SUMMARY

In accordance with the teachings of this invention, a system and method for comparing individuals, relationships and partners in a relationship and soliciting relationship advice are provided. The method comprises providing a relationship submission interface, the relationship submission interface providing a first user with the ability to submit a relationship couple and one or more questions about the relationship couple with specified answer choices; receiving the relationship couple submissions and one or more questions about the relationship couple; providing an answer submission interface, the answer submission interface providing a second user with the ability to select an answer to a question about a relationship couple; receiving the answer submission; and providing the display of the results of all relationship answer submissions.

The relationship question may contain only 2 possible answer choices. Additionally, the question about the relationship asks which member of the relationship couple is preferable or more desirable or conversely which member of the relationship couple is less preferable or less desirable.

The first user additionally may submit a secret question and the second user must answer correctly in order to select an answer to the question about the relationship couple. The first user may additionally submit a user list or a “Friends list” can be used from an interfaced ASP, and the second user must be in the user list or “Friends list” in order to select an answer to the question about the relationship couple.

### BRIEF DESCRIPTION OF THE DRAWINGS

The accompanying drawings taken in conjunction with the detail description will assist in making the advantages and aspects of the disclosure more apparent.

FIG. 1 is a block diagram of a general embodiment also showing how users interact with the system.

FIG. 2 is the database schema used in a general embodiment.

FIG. 3 is a flow chart showing how a user submits a selection and views the results.

### DETAILED DESCRIPTION

Reference will now be made in detail to the present embodiments discussed herein, illustrated in the accompanying drawings. The embodiments are described below to explain the disclosed system and method by referring to the figures using like numerals. It will nevertheless be understood that no limitation of the scope is thereby intended, such alterations and further modifications in the illustrated device, and such further applications of the principles as illustrated therein being contemplated as would normally occur to one skilled in the art to which the embodiments relate

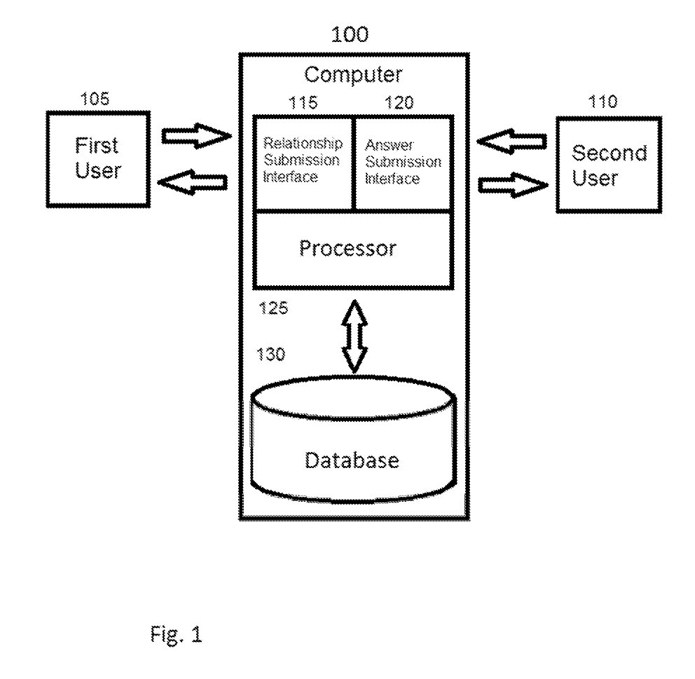

Embodiments of a system and method for comparing individuals, relationships and partners in a relationship and soliciting relationship advice are provided. As illustrated in FIG. 1, a system 100 shows a first user 105 and a second user 110 the former submitting a dating/relationship couple and question(s) through the relationship submission interface 115 and the latter submitting a response to a question about the members of the couple or the couple itself through the answer submission interface 120, along with a processer 125 which communicates with the database 130 with both users being able to view the results. In the preferred embodiment, the system can host a website, be a web application, a standalone application, or an application on an ASP.

Individuals can interact with the system as either a first user 105 or a second user 110. The terms refer to how the user is interacting with the system and through which interface the user is interacting with.

The first user 105 is the user who interacts with the relationship submission interface and submits the dating/relationship couple and question(s) to the system with the purpose of receiving relationship advice and answers to questions about the couple. The first user 105 can interact with the system directly or via a client device over a network to a server system. The network can be the internet or other networks such as intranet, LAN or WAN. This can be done through an ASP, including social networking applications, or directly by accessing the application or website, or via an application that accesses such a website, such as an application running on a mobile phone or PDA. The first user 105 may have previously registered with the system. Registration may require the creation of a login and password, which gives the first user 105 exclusive access to his personal information and account. During registration, the system checks that the user's name, login, and any other identifiers are unique to that user alone and are valid. A first user's 105 registration information is stored within the database 130. The first user may have an account profile or home page allowing him to access his profile information and any of his submissions while he/she is logged in.

The first user can then submit a dating/relationship couple or pair via the relationship submission interface 115. A couple can be any 2 people in a heterosexual or homosexual relationship. The 2 individuals, however, do not need to be currently in a relationship and can be past, future, or even hypothetical relationships. A submission often includes a picture of the couple and can include names as well as additional information about the couple. Additionally, the first user 105 can identify if he/she is one of the members of the couple or can identify his/her connection to the couple. A first user 105 can also set up if he/she wants to receive alerts or messages when a second user 115 has selected/voted on a question answer or selected/voted on a member of the couple and can specify his preferred means of receiving the alert or message such as IM, electronic mail, or ASP.

For a relationship couple, the first user 105 submits relationship questions with 2 or more specified answer choices. By having specified answer choices, it allows for the first user 105 to quickly and efficiently receive responses to his/her question. In other embodiments, the first user 105 submits questions requiring a Yes/No answer or 2 alternative answer choices. The relationship submission interface 115 provides a question field in which the first user 105 types a question. Additionally, the interface 115 provides answer fields allowing the first user 105 to type the answer choices. In an alternative embodiment, the relationship question is one of many stock questions provided by the system for the user to select. One such question may compare the 2 members of the relationship, “Which member of the relationship is more desirable?” The answer choices may be “Person 1” and “Person 2” or “John” and “Susan.” Other questions may tell a story and ask which member of the relationship is at fault or ask which course of action is preferred to remedy a problem.

In an alternative embodiment, the dating/relationship couple can be submitted to the system by a system administrator. This can occur when the couple consists of public figures, such as Brad Pitt and Angelina Jolie or some other hypothetical couple. The system administrator also submits relationship questions for such couples.

The second user 110 is the user who interacts with the answer submission interface 120 and answers a question, voting on 1 of the specified choices, about the dating/relationship couple. The second user 110 can interact with the system directly or via a client device over a network to a server system. This can be done through an ASP, including social networking applications, or directly by accessing the application or website, or via an application that accesses such a website, such as an application running on a mobile phone or PDA. The second user 110 may have registered with the system; alternatively, no registration may be required. The second user's registration information is checked by the system to be unique and is stored within the database 130.

The second user 110 selects from one of the answer choices in order to submit the answer to the question about the dating/relationship couple or pair. The answer submission interface 120 displays the couple and any additional information about the couple which was submitted by the first user 105. The user is then asked to select an answer to the question. Where the question is “Which member of the couple is better or more desirable,” the user may select “Person 1.” The second user can easily navigate through many relationship couples and questions, allowing the second user to answer multiple questions and provide advice to multiple couples.

In another embodiment, the first user 105 can submit a code word or secret question so that only friends or individuals who know the code word or the answer to the secret question can answer relationship questions for that couple. As part of the answer submission interface, the second user 110 is required to enter the code word or answer to the secret question. In another embodiment, the code word or secret question does not restrict strangers from participating, but instead is used to identify which selections are from friends (persons who know the couple) or strangers (other persons).

In yet, another embodiment the first user 105 can specify a specific list of friends or other named individuals. The second user 110 must be on the list in order to answer the relationship questions for the couple. In yet another embodiment, the list does not restrict strangers from participating, but instead is used to identify which selections are from friends or persons who know the couple. This list can be manually submitted by the first user 105 or can be taken from “Friends lists” on other ASPs, such as social networking applications, which have been successfully interfaced with the system.

The processor 125 takes the selection or vote submitted by the second user 110 and stores it in the database 130. The existence of various processing units and forms of memory may vary in different system embodiments. Some form of data storage is the only requirement.

In an embodiment where a code word or answer to the security question is submitted, the processor 125 queries the database 130 to check for a matching code word or answer to the security question. If a successful match is required, the selection will only be stored in the database 130 if the processor finds a successful match in the database. In an embodiment where a successful match is not required but still supplied, both the selection 120 and whether the match was successful will be stored in the database. In an embodiment where the first user 105 who submitted the dating/relationship couple 110 can receive alerts and messages when a vote has been made, the processor queries the database to determine if the first user has chosen to received alerts and messages. If so, an alert or message is sent to the first user 105, using his preferred method of receiving such alerts of messages.

The results of all successful votes/selections for the question for a relationship couple can be displayed to the first user or second user 105. For the second user, this would generally occur immediately after submission of an answer. For the first user, this could occur any time the first user accesses the system. The system may require the first user 105 to submit his login and password in order to access all results for a submitted dating/relationship couple. The processor 125 queries the database 130 for all voting results for the question for a dating/relationship couple, which are then displayed. The first user 105 may choose to view results as a percentage of votes or as the actual number of votes.

In an embodiment where some votes are identified as those made by users who successfully answered the code word or secret question or friends specified on a list, the results may be displayed differently. The votes by users who answered the code word or secret question or friends specified on a list may be displayed separately from the votes of those who did not answer correctly or were not specified on a list. A first user may want to identify results among friends separately from strangers For example, 25 total votes were received for a couple. Answer Choice 1 received 5 votes from friends and 5 votes from strangers. Answer Choice 2 received 10 votes from friends and 5 votes from strangers. The results could then be displayed as 10 to 5 in favor of Answer Choice 2 among friends, who knew the code word or were specified on a list, and a 5 to 5 tie among strangers, who did not know the code word or were not specified on a list.

In another embodiment, the votes of users who answered the code word or secret question or friends specified on a list may be given more weight compared to votes of users who did not answer the code word or secret question or were not specified on a list. A user may trust the opinion of friends and therefore want their votes to be counted more than votes of strangers. For example, 25 total votes were received for a couple. Votes from friends who knew the code word or were specified on the list are given a weight of 5 votes from strangers who did not know the code word or were not specified on the list. Answer Choice 1 received 5 votes from friends and 5 votes from strangers. The votes for Choice 1 are calculated as 5×5+5=30. Answer Choice 2 received 10 votes from friends and 5 votes from strangers. The votes for Choice 2 are calculated as 10×5+5=55. The results could then be displayed as 55 to 30 in favor of Choice 2.

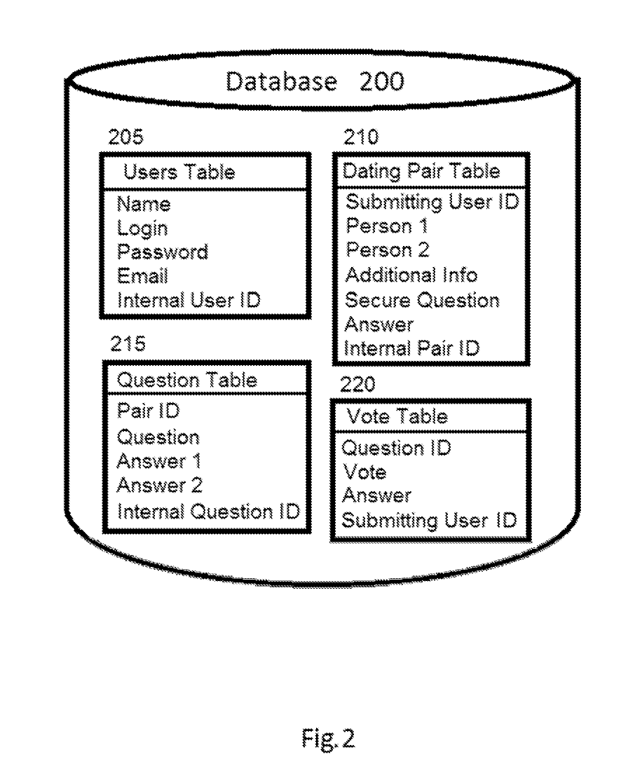

As illustrated in FIG. 2, in the preferred embodiment, database 200 consists of a Users table 205, a Dating Pairs or Couples table 210, a Questions table 215 and a Votes table 220.

The Users table 205 stores the information of registered users, which may correspond to a second user 115 from FIG. 1 or to a first user 105 from FIG. 1. The table consists of the name of the user, and may include login and password information. The login and password information, if used, allows the user to securely access information from the website or application. Additionally, the users table may include the electronic mail address, IM address, ASP identity, or any other communications designator. Lastly, the users table contains an internal user ID used to link tables.
Sample content for a row in the Users table is provided.
Name: John Smith
Login: jsmith
Password: 12345
Email: jsmith@emailme.com
Internal User ID: 11

The Dating Pairs or Couples table 210 stores the information of a dating/relationship couple or hypothetical couple. The table consists of the user ID of the user who submitted the couple, matching the internal user ID of the Users table 205 and corresponding to a first user 105 from FIG. 1. The table contains the names of the members of the dating couple, and may include additional information. In the additional information, the submitting user may identify if he is one of the members of the dating couple or how he/she knows them. In another embodiment, the table may include a code word or secret question and answer allowing only users who know the code word or answer to the secret question to vote. Lastly, the table contains an internal pair ID value used to link tables. Sample content for a row in the Dating Pairs or Couples table is provided.
Submitting User ID: 11
Person 1: John
Person 2: Susan
Additional Info: I am John. Susan and I have been together for 1 year
Secret Question: What is John's favorite food?
Answer: Pizza
Internal Pair ID: 26

The Questions table 215 stores the information of all submitted questions on dating couples. The table consists of a pair ID matching the internal pair ID of the Dating Pairs table 210. The table contains the relationship question and the answer choices. In this embodiment only 2 choices are submitted. Lastly, the table contains an internal question ID used to link tables.
Sample content for a row in the Votes table is provided.
Question ID: 35
Question: Which member of the dating couple has better clothing style?
Answer 1: John
Answer 2: Susan
Pair ID: 26

The Votes table 220 stores the information of all submitted votes/answers on dating couples questions. The table consists of a pair ID matching the internal question ID of the Questions table 215. The table contains which answer to the question was chosen, the vote. It may also contain the whether the person voting answered the secret question or code word correctly. Lastly, if the user submitting the vote is a registered user, it may contain a user ID matching the internal user ID of the Users table 205.
Sample content for a row in the Votes table is provided.
Question ID: 35
Vote: Susan
Answer: Yes
Submitting User ID: 12

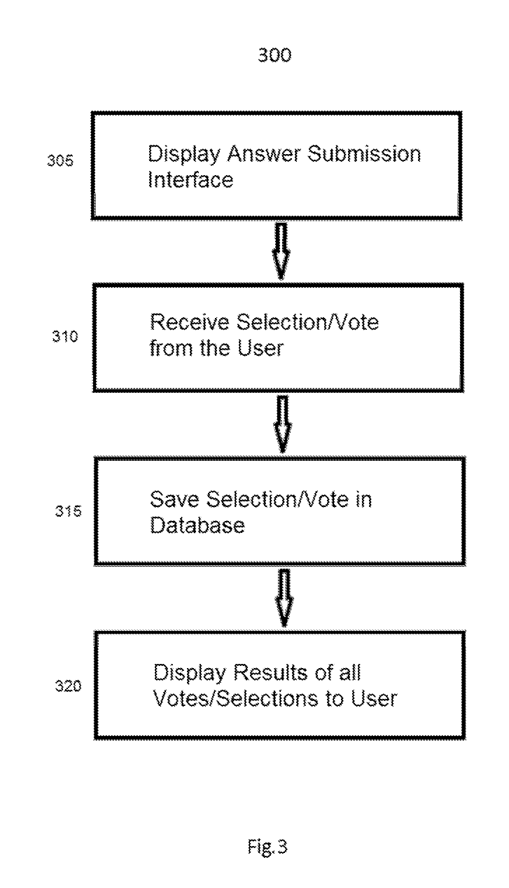

As illustrated in FIG. 3, a flow chart 300 showing a how a user, corresponding to a second user 115 from FIG. 1, interacts with the system which displays the selection interface 305, receives a vote or selection 310, stores it in the database 315, and displays it to the user 320.

A second user interacts with the system through the answer submission interface. The interface displays to the user the dating relationship couple or pair, the relationship questions, along with any additional information 305. The additional information can include names and descriptions of the members of the couple. The user answers the question by choosing from the provided answer choices. The user's selection is received by the answer submission interface 310. The processor takes the submitted selection for the couple and stores it in the database 315. The processor then queries the database for all votes received for that couple. The result for the question is then displayed to the user 320. The user can return to the answer submission interface and selecting answers to additional relationship questions about additional relationship couples.

That which is claimed is:

1. A computer-implemented method comprising:
providing a relationship submission interface, the relationship submission interface providing a first user with the ability to submit a relationship couple and one or more questions about the relationship couple with specified answer choices;
receiving the relationship couple submissions and one or more questions about the relationship couple;
providing an answer submission interface, the answer submission interface providing a second user with the ability to select an answer to a question about a relationship couple;
receiving the answer submission; and
providing the display of the results of all relationship answer submissions.

2. The method of claim 1 wherein the question about the relationship has only 2 possible answers to choose from.

3. The method of claim 1 wherein the question about the relationship asks which member of the relationship couple is preferable or more desirable or conversely which member of the relationship couple is less preferable or less desirable.

4. The method of claim 1 wherein the first user additionally submits a secret question and the second user must answer correctly in order to select an answer to the question about the relationship couple.

5. The method of claim 1 wherein the first user additionally submits a secret question and the second user, by answering correctly, is identified as a friend of the first user.

6. The method of claim 5 wherein answer submissions by a friend are weighted more heavily than those of other users.

7. The method of claim 5 wherein answer submissions by a friend are displayed separately from those of other users.

8. The method of claim 1 wherein the first user additionally submits a user list and the second user must be in the user list in order to select an answer to the question about the relationship couple.

9. The method of claim 1 wherein the first user additionally submits a user list and the second user, by being in the user list, is identified as a friend of the first user.

10. The method of claim 1 wherein the first user's existing “Friends list” from an ASP is provided and the second user must be in the user list in order to select an answer to the question about the relationship couple.

11. The method of claim 1 wherein the first user's existing “Friends list” from an ASP is provided and used to identify a friend of the first user.

12. A computer-implemented method comprising:
populating a relationship couple and one or more questions about the relationship couple with specified answer choices;
providing an answer submission interface, the answer submission interface providing a user with the ability to select an answer to a question about a relationship couple;
receiving the answer submission; and
providing the display of the results of all relationship answer submissions.

13. The method of claim 12 wherein the question about the relationship has only 2 possible answers to choose from.

14. The method of claim 12 wherein the question about the relationship asks which member of the relationship couple is preferable or more desirable or conversely which member of the relationship couple is less preferable or less desirable.

15. A system comprising:
a computer receiving a submitted relationship couple and one or more questions with specified answer choices about the relationship couple, receiving an answer to a question about a relationship couple, and displaying the results of all relationship answer submissions.

16. The system of claim 15 wherein the question about the relationship has only 2 possible answers to choose from.

17. The system of claim 15 wherein the question about the relationship asks which member of the relationship couple is preferable or more desirable or conversely which member of the relationship couple is less preferable or less desirable.

18. The method of claim 15 wherein the first user additionally submits a secret question and the second user must answer correctly in order to select an answer to the question about the relationship couple.

19. The system of claim 15 wherein the first user additionally submits a secret question and the second user, by answering correctly, is identified as a friend of the first user.

20. The system of claim 15 wherein the first user additionally submits a user list and the second user must be in the user list in order to select an answer to the question about the relationship couple.
